(19) United States
(12) Patent Application Publication
(10) Pub. No.: US 2014/0204005 A1
(43) Pub. Date: Jul. 24, 2014

(54) SYSTEM, METHOD, AND COMPUTER PROGRAM PRODUCT FOR DISTRIBUTED PROCESSING OF OVERLAPPING PORTIONS OF PIXELS

(71) Applicant: NVIDIA CORPORATION, Santa Clara, CA (US)

(72) Inventors: David Wyatt, San Jose, CA (US); Toby Butzon, San Jose, CA (US); Harish Chander Rao Vutukuru, San Jose, CA (US); David Matthew Stears, San Jose, CA (US)

(73) Assignee: NVIDIA CORPORATION, Santa Clara, CA (US)

(21) Appl. No.: 13/745,705

(22) Filed: Jan. 18, 2013

(51) Int. Cl. G09G 3/36

(52) U.S. Cl. CPC G09G 3/3611
USPC 345/87

(57) ABSTRACT

A system, method, and computer program product are provided for distributed processing of overlapping portions of pixels. In use, a plurality of pixels to be processed utilizing a plurality of display processing modules across a plurality of interfaces are identified. Additionally, the pixels are apportioned into a plurality of overlapping portions of the pixels in accordance with a number of the display processing modules and display interfaces. Further, processing of the overlapping portions of the pixels is distributed across the display processing modules and the display interfaces in such way that the portions can be recombined into a single contiguous final image by a plurality display controllers.

### FIELD OF THE INVENTION

The present invention relates to processing pixels, and more particularly to processing pixels in a distributed processing environment.

### BACKGROUND

Traditionally, pixels are processed for various reasons prior to being output on a display. To increase pixel processing capabilities, systems have been developed in which processing of the pixels is distributed. For example, different groups of pixels in a single image may be processed by different processing modules. The display arrangement of the different processed pixel groups may vary, such as by combining the groups to form a single image on a single display or by outputting each processed pixel group to a separate display. In any case, the distributed processing of pixels has generally been associated with various limitations.

Just by way of example, the arrangement of the processed pixel groups conventionally results in at least one visible seam (e.g. edge) where the pixels of one processed group are adjacent to the pixels of another processed group. In such an example, two processed pixel groups may be combined in a left/right configuration with the seam being a vertical line done the center where the left positioned processed pixel group meets the right positioned processed pixel group. The visibility of the seam may be caused by variations in the processing performed by the processing modules, such as when pixels forming the edges for a group are processed differently than pixels within the edges for that group. In other embodiments, the visibility of the seam may be caused when an output pixel resulting from the processing of a particular group is supposed to be derived from neighboring pixels of that output pixel but the particular pixel group does not include all of the neighboring pixels for that output pixel (e.g. the output pixel is an on an edge of the pixel group).

There is thus a need for addressing these and/or other issues associated with the prior art.

### SUMMARY

A system, method, and computer program product are provided for distributed processing of overlapping portions of pixels. In use, a plurality of pixels to be processed utilizing a plurality of processing modules and/or display interfaces are identified. Additionally, the pixels are apportioned into a plurality of overlapping portions of the pixels in accordance with a number of the processing modules and a number of the display interfaces. Further, processing of the overlapping portions of the pixels is distributed across the processing modules. Still yet, transmission of the overlapping portions of the pixels is distributed across the display interfaces,

### BRIEF DESCRIPTION OF THE DRAWINGS

FIG. 1 shows a method for distributed processing of overlapping portions of pixels, in accordance with one embodiment.

FIG. 2 illustrates a method for outputting to a display a result of distributed processing of overlapping portions of pixels, in accordance with another embodiment.

FIG. 3 illustrates an image apportioned into overlapping portions, in accordance with yet another embodiment.

FIG. 4 illustrates a system for outputting to multiple displays a result of distributed processing of overlapping portions of pixels, in accordance with another embodiment.

FIG. 5 illustrates a system for outputting to a single display a result of distributed processing of overlapping portions of pixels, in accordance with another embodiment.

FIG. 6 illustrates a system with a single graphics processing unit (GPU) for distributed processing of overlapping portions of pixels, in accordance with yet another embodiment.

FIG. 7 illustrates a system with multiple GPUs for distributed processing of overlapping portions of pixels, in accordance with still yet another embodiment.

FIG. 8 illustrates a system with a single GPU, timing controllers having bi-directional communication therebetween, and multiple display interfaces for distributed processing of overlapping portions of pixels, in accordance with another embodiment.

FIG. 9 illustrates a system with a single GPU, timing controllers having uni-directional communication therebetween, and multiple display interfaces for distributed processing of overlapping portions of pixels, in accordance with another embodiment.

FIG. 10 illustrates a system a system with a single GPU, a single timing controller in communication with a line buffer, and multiple display interfaces for distributed processing of overlapping portions of pixels, in accordance with another embodiment.

FIG. 11 illustrates an exemplary system in which the various architecture and/or functionality of the various previous embodiments may be implemented.

### DETAILED DESCRIPTION

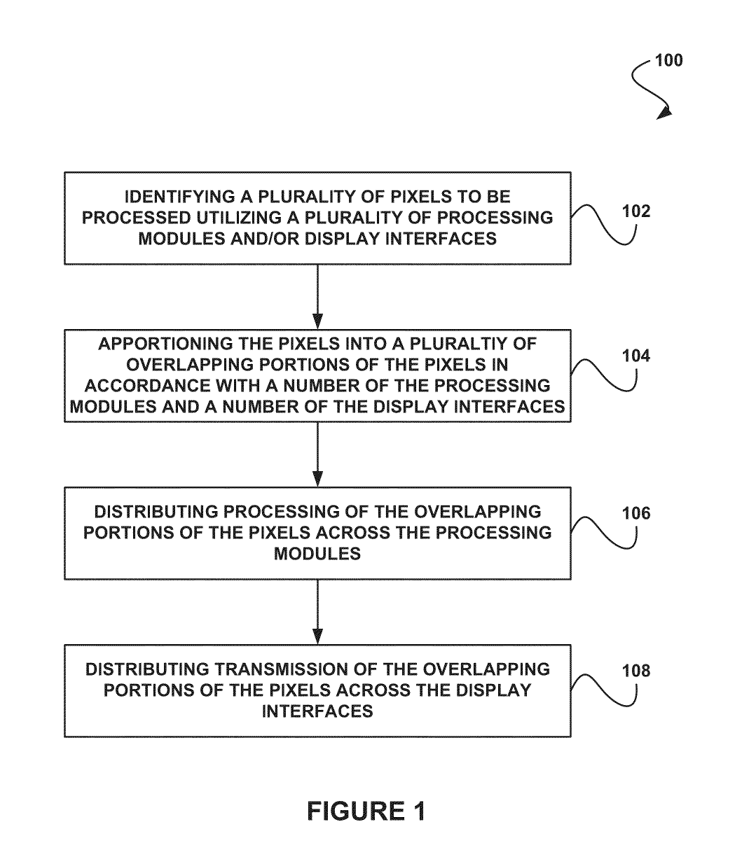

FIG. 1 shows a method 100 for distributed processing of overlapping portions of pixels, in accordance with one embodiment. As shown in operation 102, a plurality of pixels to be processed utilizing a plurality of processing modules and/or a plurality of display interfaces are identified. The pixels may be any set of pixels to be processed utilizing the processing modules. For example, the pixels may form an image frame.

As an option, the pixels may be identified in response to being received from an application. The application may be a user interface based application, such as a gaming application, user software application, etc. In this way, the pixels may be identified in response to being received from the application for performing the aforementioned processing and subsequent output thereof for display.

Of course, it should be noted that the pixels may be identified in any other manner related to subsequent processing utilizing the processing modules. In one embodiment, the pixels may be received by a pixel pipeline including the processing modules to be utilized for processing the pixels. In various examples, such processing of the pixels may include scaling, dithering, etc. (e.g. of the image frame).

Additionally, as shown in operation 104, the pixels are apportioned into a plurality of overlapping portions of the pixels in accordance with a number of the processing modules and a number of the display interfaces. The processing modules may be any processing circuitry (of one or more graphics processors) capable of being utilized to process the pixels. In addition, the display interfaces may be any interfaces to a display device that are capable of transmitting the processed pixels to the display device.

In the present description, apportioning the pixels into the overlapping portions may include sub-dividing, partitioning, or otherwise separating the pixels into pixel groups (i.e. portions) that are at least in part overlapping. The pixels may be apportioned as noted above in any preconfigured manner that results in the overlapping portions of the pixels. Thus, the overlapping portions resulting from the apportioning may take any preconfigured form. For example, the pixels may be apportioned into adjacent blocks of pixels. In another example, the pixels may be apportioned into separate rows. In any case, the pixels may be apportioned in such a way that the pixels from the portions are capable of being combined to form a single contiguous image frame.

The extent to which the portions overlap may be predefined and may be a result of the particular manner in which the apportioning is performed. For example, the extent to which the portions overlap may be predefined to be a sub-block of pixels, where specifically the overlap may be in the form of the sub-block of pixels. Further examples of the overlapping nature of the various portions of pixels will be described with reference to the subsequent figures below.

In one embodiment, the extent to which the portions overlap may be computed based on a size of a final image, a number and arrangement of the portions, and a degree of image filtering required from each portion. Optionally, a determined amount of overlap of the overlapping portions may be pre-fixed or dynamically programmed into a display device controller.

Moreover, each of the portions of the pixels resulting from the apportioning may be overlapping with respect to at least one of the other portions of the pixels resulting from the apportioning. It should be noted that the overlapping nature of the portions of the pixels may be such that each of the overlapping portions has pixels overlapping with at least one other of the overlapping portions. In an embodiment where the pixels are apportioned into adjacent blocks, rows, etc., each particular portion of the pixels (e.g. block) may only be overlapping with respect to other portions of the pixels (e.g. other blocks) with which that particular portion of the pixels is adjacent.

As noted above, the pixels are apportioned in accordance with the number of the processing modules and the number of display interfaces. In one embodiment where there is a one-to-one ratio of processing modules to display interfaces, the pixels may be apportioned into a same number of overlapping portions as the number of the processing modules (and the same number of corresponding display interfaces), such that each processing module is assigned one of the overlapping portions for processing thereof. In another embodiment where there is a one-to-many ratio of processing modules to display interfaces, the pixels may be apportioned into a number of overlapping portions that is a multiple of the number of the processing modules (and is a same number of display effaces), such that each processing module is assigned a same number of the overlapping portions for processing thereof and such that each display interface transmits a different processed portion to a display device.

Further, as shown in operation 106, processing of the overlapping portions of the pixels is distributed across the processing modules. Distributing processing of the overlapping portions across the processing modules may include sending to each of the processing modules a different one (or more) of the overlapping portions. As noted above, the processing may be scaling, dithering, etc. of the overlapping portions. Such distribution may be used to increase processing speed of the pixels received in operation 102, increase processing power applied to the pixels received in operation 102, etc.

Just by way of example, the processing of a particular one of the overlapping portions of the pixels may use at least a first portion of pixels included therein that overlap with at least one other of the overlapping portions to process at least a second portion of pixels included therein that do not overlap with at least one other of the overlapping portions. Thus, the processing may take into account the pixels that are overlapping when processing the non-overlapping pixels.

Just by way of example, when scaling the pixels (e.g. that form an image) to a larger size, the scaling may be performed by generating new pixels that are additional to the identified pixels used as input to a function performing the scaling. Each of these new pixels may be generated specifically by applying the function to neighboring pixels of the the new pixel, such as by applying the function to color components or other features of the neighboring pixels to determine the color components or other features of the new pixel. In situations where a new pixel generated for a particular portion of the pixels is located on a seam (i.e. edge) between two of the adjacent overlapping portions, the new pixel may be generated using the neighboring pixels that are overlapping with respect to the particular portion of the pixels and the adjacent portion of the pixels. Thus, scaling the image in each of the overlapping portions to form a single contiguous whole image frame may be accomplished by reusing pixels of neighboring overlapping portions in a scaling filter of the processing module.

As another example, where pixels forming an edge for a particular one of the portions of the pixels (i.e. outer pixels) are processed differently than pixels within the edges for that particular portion (i.e. inner pixels), the overlapping pixels may be included in the particular portion such that the pixels along the seam between the particular portion and another adjacent portion of the pixels are considered inner pixels, and therefore processed as inner pixels. Thus, all non-overlapping pixels of the particular portion may be considered inner pixels, and thus processed the same, as a result of including the overlapping pixels in the particular portion of the pixels.

To this end, visible seams otherwise occurring between adjacent portions of pixels not having overlapping pixels may be avoided. For example, differences in pixel processing due to the overlapping pixels not being available to a particular processing module (e.g. inability to use neighboring pixels, variation in processing outer pixels, etc.) which results in a visible seam, may be prevented (and thus the visible seam prevented) by providing to the processing module pixels that overlap with one of the adjacent portions (i.e. located on the other side of the seam).

Still yet, as shown in operation 108, transmission of the overlapping portions of the pixels is distributed across the display interfaces. For example, each display interface may transmit a different one of the overlapping portions to a display device for display thereof. In particular, each of the display interfaces may receive an overlapping portion processed by one of the processing modules and may transmit such processed overlapping portion to the display device. It should be noted that an entirety of the overlapping portion processed by the processing module may be transmitted via a display interface, or a sub-portion of the overlapping portion processed by the processing module may be transmitted via a display interface (e.g. where overlapping pixels have been discarded), as described in more detail below. To this end, processing of the overlapping portions of the pixels may be distributed across the display processing modules and the display interfaces in such way that the portions can be recombined into a single contiguous final image by a plurality display controllers.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

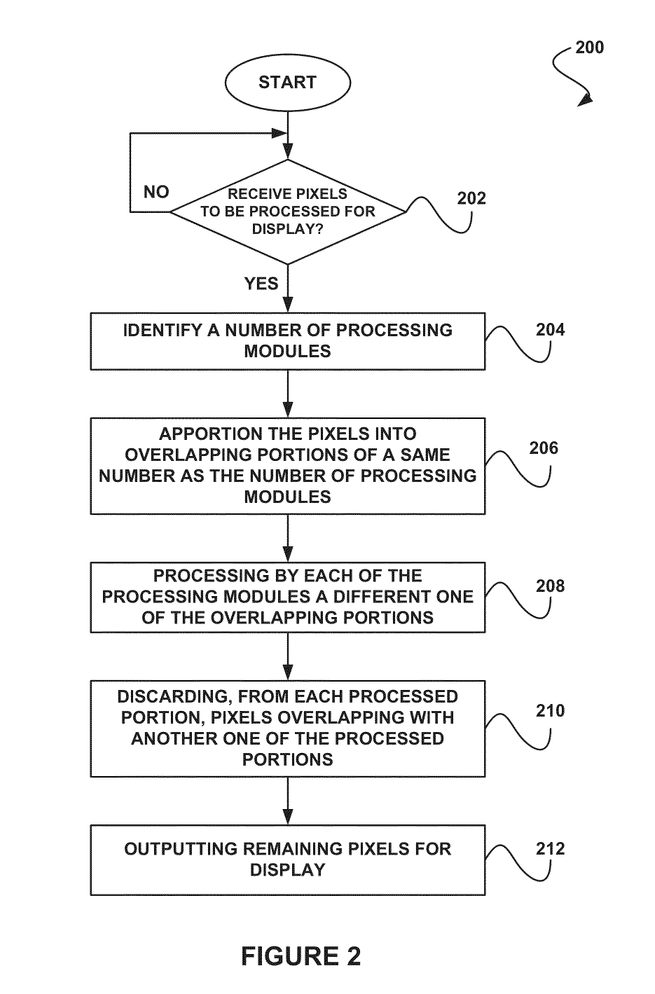

FIG. 2 illustrates a method 200 for outputting to a display a result of distributed processing of overlapping portions of pixels, in accordance with another embodiment. As an option, the present method 200 may be carried out in the context of the method 100 of FIG. 1. Of course, however, the method 200 may be carried out in any desired environment. It should also be noted that the aforementioned definitions may apply during the present description.

As shown in decision 202, it is determined whether pixels to be processed are received for display. For example, the pixels may be received from a user interface based application for being output on the display in the form of the user interface. Prior to being displayed, however, processing of the pixels may be required. For example, the pixels may be received with a command to scale an image formed by the pixels, perform dithering with respect to the image formed by the pixels, etc.

If it is determined that pixels to be processed are not received for display, the method 200 continues to wait for pixels to be received. Once it is determined that pixels to be processed are received for display, a number of processing modules are identified. Note operation 204. The number may be any numerical value indicating a count of the processing modules to be utilized for processing the pixels.

The pixels are then apportioned into overlapping portions of a same number as the number of the processing modules, as shown in operation 206. The apportioning may be performed in any manner that results in the same number of portions as the number of the processing modules, where such resulting portions are at least in part overlapping with one another. Of course, as another option (not shown) the pixels may be apportioned into a number of overlapping portions that is a multiple of the number of the processing modules. In either case, the pixels may be apportioned for even distribution of the portions of the pixels across the processing modules.

As shown in operation 208, each of the processing modules then processes a different one of the overlapping portions. The processing may include generating a set of final pixels to be displayed. For example, a different one of the overlapping portions may be input to one of the processing modules, and the processing module may use the pixels of the inputted overlapping portion to generate the set of set of final pixels to be displayed pixels to be displayed. Such processing may specifically use pixels of the inputted overlapping portion that are overlapping with at least one other of the overlapping portions in order to generate the set of final pixels to be displayed.

Further, for each of the processed portions (that is the output resulting from operation 208), pixels overlapping with another one of the processed portions are discarded. Note operation 210. Thus, for each of the processed portions, a sub-portion of the processed portion that consists solely of pixels overlapping with another one of the processed portions may be discarded (e.g. removed) from the set of final pixels generated for that processed portion. Such sub-portion may be identified for discarding thereof in any desired manner, such as for example by marking the pixels of the sub-portion, including with each processed portion a parameter indicative of the sub-portion, identifying a preconfigured number of pixels from each edge of the processed portions adjacent to another one of the processed portions, being pre-programmed in advance with a constant indicating the sub-portion for all processed portions, etc.

As an option, the set of final pixels may be transmitted to a display device(s) and the discarding may be performed by the display device(s) prior to displaying a remaining portion of the set of final pixels. As another option, the discarding may be performed by the processing module that generated the set of final pixels or by a display controller, and thus prior to being sent to a display device(s). Performing the discarding by the processing modules/display controller (as opposed to by the display device(s)) may reduce bandwidth required for transmitting pixels to be displayed to a display device(s) by reducing a number of the pixels transmitted to the display device(s), may reduce interoperability burdens placed on the display device(s) by preventing the display device(s) from having to determine which pixels to discard, etc.

The remaining pixels are then output for display, as shown in operation 212. For example, where the discarding is performed by the processing modules, the pixels remaining after the discarding of operation 210 may be output to the display device(s) for use by the display device(s) in displaying the remaining pixels. As another example, where the discarding is performed by the display device(s), the pixels remaining after the discarding of operation 210 may be output to a display panel of the display device(s). In either case, the display device(s) may display the remaining pixels (e.g. to form the processed user interface formed by the remaining pixels). It should be noted that the outputting of operation 212 may be performed in a distributed manner using multiple display interfaces, as described above with respect to operation 108 of FIG. 1.

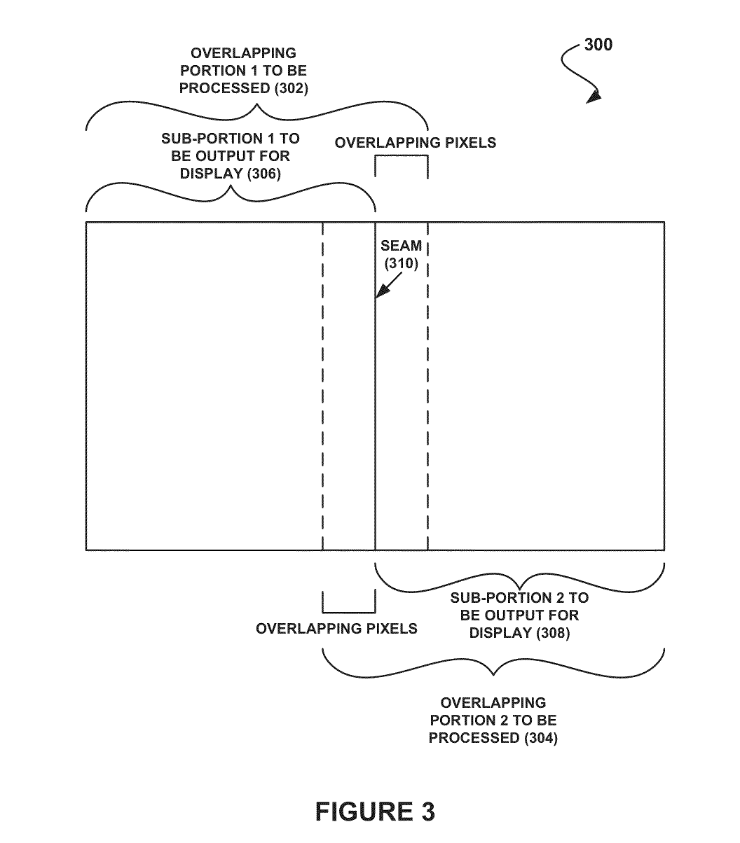

FIG. 3 illustrates an image 300 apportioned into overlapping portions, in accordance with yet another embodiment. As an option, the image 300 may be implemented in the context of FIGS. 1-2. Of course, however, the image 300 may be implemented in any desired environment. Again, it should also be noted that the aforementioned definitions may apply during the present description.

As shown, an image 300 apportioned into two overlapping portions 302 and 304. The image 300 is comprised of a plurality of pixels, such that the two overlapping portions 302 and 304 are each comprised of overlapping portions of those pixels. Specifically, a first one of the overlapping portions 302 is comprised of a first portion of the pixels that overlaps at least in part with a second portion of the pixels comprising a second one of the overlapping portions 304. While the overlapping portions 302 and 304 are shown in a left/right configuration, it should be noted that the overlapping portions 302 and 304 may be defined in any configuration with respect to the image 300, such as a top/bottom configuration, etc.

The extent to which the portions 302 and 304 are overlapping may be preconfigured and may result from a specific manner in which a function utilized to generate the two overlapping portions 302 and 304 apportions the image 300. In the present embodiment, the portions 302 and 304 are overlapping by including in each of the portions 302 and 304 a block of pixels included in the other one of the portions 302 and 304.

Each of the overlapping portions 302 and 304 are input to and processed by a separate processing module. Thus, in the present embodiment, two processing modules are utilized for the processing, namely each of the overlapping portions 302 and 304 is input to and processed by a different one of the two processing modules. From the processing, a final set of pixels is generated by each processing module.

The pixels included in each final set of pixels generated for a particular one of the portions 302 and 304 that overlap with pixels of the other one of the portions 302 and 304 are then discarded to form sub-portions of pixels 306 and 308 to be output for display. As shown, the final set of pixels generated from the first one of the overlapping portions 302 is generated, and the pixels included therein that overlap with the second one of the overlapping portions 304 are discarded to form a first sub-portion of pixels 306 to be output for display Similarly, the final set of pixels generated from the second one of the overlapping portions 304 is generated and the pixels included therein that overlap with the first one of the overlapping portions 302 are discarded to form a second sub-portion of pixels 308 to be output for display.

By discarding the pixels overlapping between the two portions 302 and 304, the remaining sub-portions 306 and 308 may be combined at a seam 310 adjoining the two sub-portions 306 and 308. The adjoined sub-portions 306 and 308 may then be displayed. Further, by generating each of the sub-portions of pixels 306 and 308 in a manner that takes into account pixels included in the other of the sub-portions of pixels 306 and 308 (i.e. pixels overlapping with the other of the sub-portions of pixels 306 and 308), visibility of the seam 310 when the adjoined sub-portions 306 and 308 are displayed may be reduced and/or prevented.

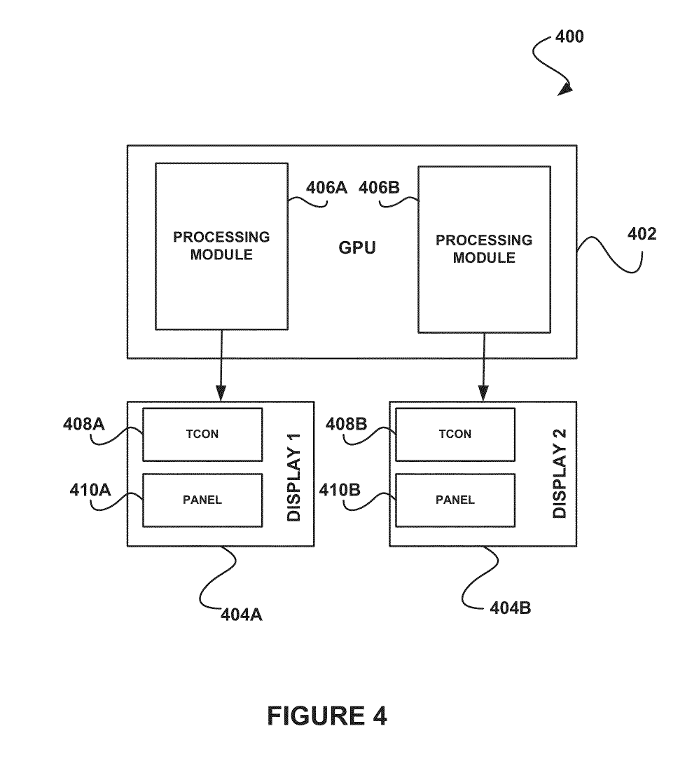

FIG. 4 illustrates a system 400 for outputting to multiple displays a result of distributed processing of overlapping portions of pixels, in accordance with another embodiment. As an option, the system 400 may be implemented in the context of the functionality of environment of FIGS. 1-3, Of course, however, the system 400 may be implemented in any desired environment. It should also be noted that the aforementioned definitions may apply during the present description.

As shown, a processor 402, shown as a graphics processing unit (GPU) in the present embodiment, is in communication with a plurality of display devices 404A-B. It should be noted that while the processor 402 is shown as a GPU, the processor may be any processor (e.g. graphics processor, etc.) capable of processing pixels to be displayed by the display devices 404A-B. Further, while only two display devices 404A-B are shown, it should be noted that any number of different display devices may be driven by the processor 402.

The processor 402 includes multiple processing modules 406A-B, each one of which is in communication with and drives a separate one of the display devices 404A-B. The processing modules 406A-B may be any hardware or software components of the processor 402 capable of processing pixels prior to being output to the display devices 404A-B. For example, the processing modules 406A-B may be components of a pixel. pipeline (with other components of the pixel pipeline not necessarily shown in the present system 400).

The processing modules 406A-B may be in communication with an application or other system 400 component (not shown) from which pixels to be processed for output to the display devices 404A-B may be received. In the present embodiment, each of the processing modules 406A-B receives a respective one of overlapping portions of a set of pixels (e.g. that forms an image) for processing thereof. The processing modules 406A-B may then output a final set of pixels resulting from the processing to the display devices 404A-B.

The display devices 404A-B each include a timing controller (TCON) 408A-B and a display panel 410A-B. The TCON 408A-B may write pixels to the display panel 410A-B according to a timing preconfigured for the respective display device 404A-B, such that the pixels are viewable by a user viewing the respective display device 404A-B. In one embodiment, upon receipt by each of the display devices 404A-B of the final set of pixels from a corresponding one of the processing modules 406A-B, the display device 404A-B may discard the pixels included therein that overlap with the other one of the final set of pixels received by the other display device 404A-B. For example, the TCON 508 of the single display device 504 may identify the overlapping pixels and discard the identified overlapping pixels. The pixels remaining after the discarding is performed may then be written to the display panel 410A-B of the display device 404A-B using the TCON 408A-B. Thus, the overlapping pixels included in each of the final sets of pixels may be prevented from being written to the display devices 404A-B.

In another embodiment, the processing modules 406A-B may each identify the overlapping pixels and discard the identified overlapping pixels prior to outputting pixels to the respective display device 404A-B. Thus, only the pixels remaining after the discarding is performed may be output to the display devices 404A-B. This embodiment may allow each of the display devices 404A-B to write the received pixels to the display panel 410A-B as is customary, without requiring the display devices 404A-B to be configured to identify and discard the overlapping pixels.

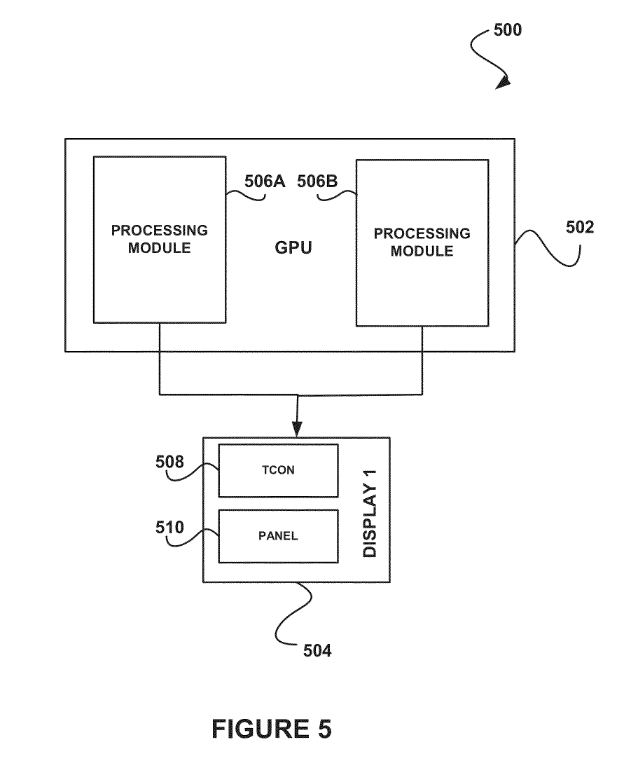

FIG. 5 illustrates a system 500 for outputting to a single display a result of distributed processing of overlapping portions of pixels, in accordance with another embodiment. As an option, the system 500 may be implemented in the context of the functionality of environment of FIGS. 1-3. Of course, however, the system 500 may be implemented in any desired environment. It should also be noted that the aforementioned definitions may apply during the present description.

As shown, a processor 502, shown as a graphics processing unit (GPU) in the present embodiment, is in communication with a single display device 504. It should be noted that while the processor 502 is shown as a GPU, the processor may be any processor (e.g. graphics processor, etc.) capable of processing pixels to be displayed by the display device 504.

The processor 502 includes multiple processing modules 506A-B, each one of which is in communication with and drives the single display device 504. The processing modules 506A-B may be any hardware or software components of the processor 502 capable of processing pixels prior to being output to the single display device 504. For example, the processing modules 506A-B may be components of a pixel pipeline (with other components of the pixel pipeline not necessarily shown in the present system 500).

The processing modules 506A-B may be in communication with an application or other system 500 component (not shown) from which pixels to be processed for output to the single display device 504 may be received. In the present embodiment, each of the processing modules 506A-B receives a respective one of overlapping portions of a set of pixels (e.g. that forms an image) for processing thereof. The processing modules 506A-B may then output a final set of pixels resulting from the processing to the single display device 504.

The single display device 504 includes a timing controller (TCON) 508 and a display panel 510. The TCON 508 may write pixels to the display panel 510 according to a timing preconfigured for the single display device 504, such that the pixels are viewable by a user viewing the single display device 504. In one embodiment, upon receipt by the single display device 504 of the two final sets of pixels from the processing modules 506A-B, the single display device 504 may discard the pixels included in each of the final sets of pixels that overlap with the other one of the final sets of pixels. For example, the TCON 508 of the single display device 504 may identify the overlapping pixels and discard the identified overlapping pixels.

In another embodiment, the processing modules 506A-B may each identify the overlapping pixels and discard the identified overlapping pixels prior to outputting pixels to the single display device 504. Thus, only the pixels remaining after the discarding is performed may be output to the single display device 504. This embodiment may allow the single display device 504 to write the received pixels to the display panel 510 as is customary, without requiring the single display device 504 to be configured to identify and discard the overlapping pixels.

The pixels remaining after the discarding is performed may then be adjoined by the single display device 504 and written to the display panel 510 of the single display device 504 using the TCON 508. Thus, the overlapping pixels included in each of the final sets of pixels may be prevented from being written to the single display device 504.

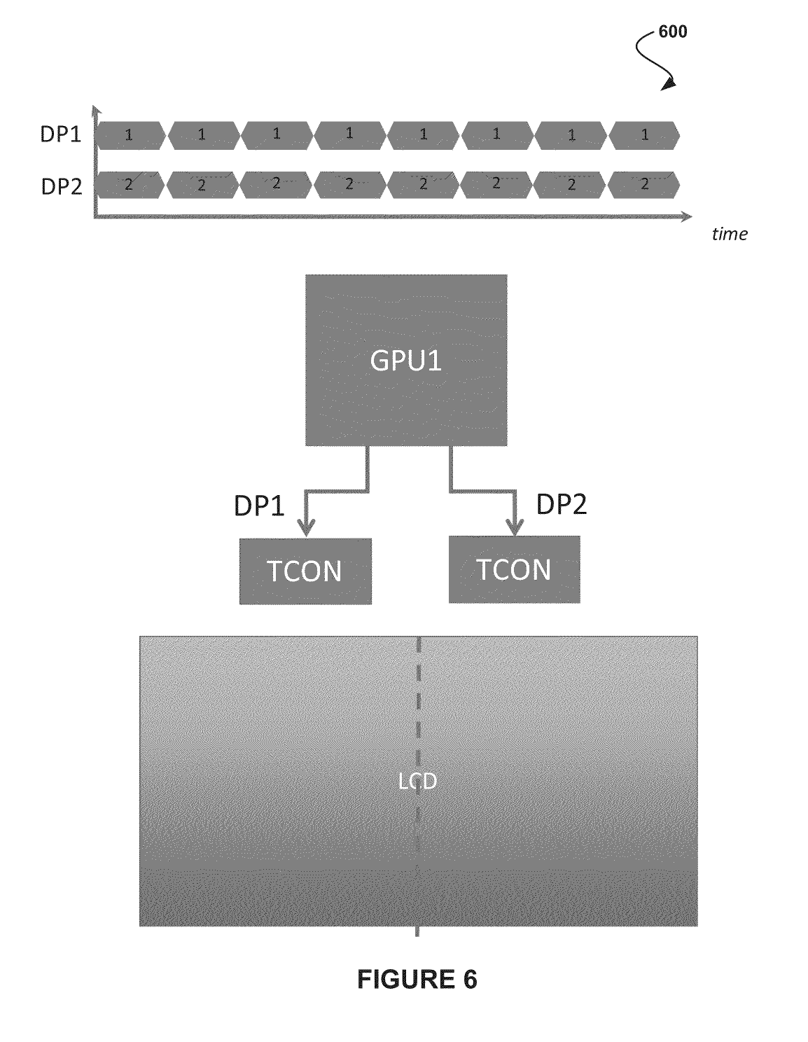

FIG. 6 illustrates a system 600 with a single graphics processing unit (GPU) for distributed processing of overlapping portions of pixels, in accordance with yet another embodiment. As an option, the system 600 may be implemented in the context of the functionality of environment of FIGS. 1-3. Of course, however, the system 600 may be implemented in any desired environment. It should also be noted that the aforementioned definitions may apply during the present description.

As shown, a processor, shown as a GPU in the present embodiment, is in communication with a plurality of timing controllers (TCONs) each associated with a separate display device. In the present embodiment, the processor includes multiple processing modules, each one of which is in communication with a respective one of the TCONs. As shown, the GPU communicates with each of the TCONs via a separate communications bus (shown as DP1 and DP2, respectively).

Each of the processing modules receives a respective one of overlapping portions of a set of pixels (e.g. that forms an image) for processing thereof. The processing modules may each then output a final set of pixels resulting from the processing to the respective display device via the associated TCON. As shown, over time a first processing module solely communicates with a first TCON over the first communications bus (DP1), such that for each image processed by the GPU the first processing module is responsible for processing a first overlapping portion of the image for display by a first one of the display devices. Similarly, over time a second processing module solely communicates with a second TCON over the second communications bus (DP2), such that for each image processed by the GPU the second processing module is responsible for processing a second overlapping portion of the image for display by a second one of the display devices.

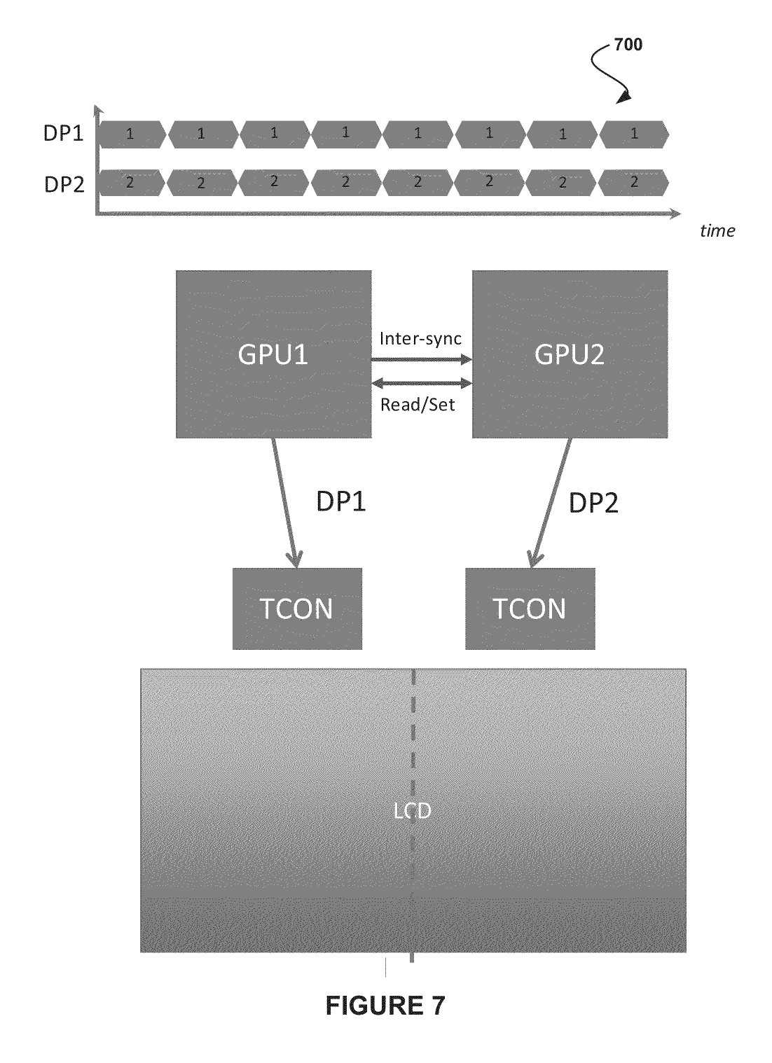

FIG. 7 illustrates a system 700 with multiple GPUs for distributed processing of overlapping portions of pixels, in accordance with still yet another embodiment. As an option, the system 700 may be implemented in the context of the functionality of environment of FIGS. 1-3. Of course, however, the system 700 may be implemented in any desired environment. It should also be noted that the aforementioned definitions may apply during the present description.

The system 700 of FIG. 7 operates similarly to that system 600 of FIG. 6, with the exception that the system 700 of FIG. 7 includes multiple GPUs each of which communicate with a different one of the TCONs. In the present embodiment, each of the GPUs may include multiple processing modules, where the processing modules of both GPUs each process overlapping portions of a same image frame. Bi-directional communication is established between the GPUs, as shown, to facilitate the apportioning and associated distribution of the overlapping portions of the image frame.

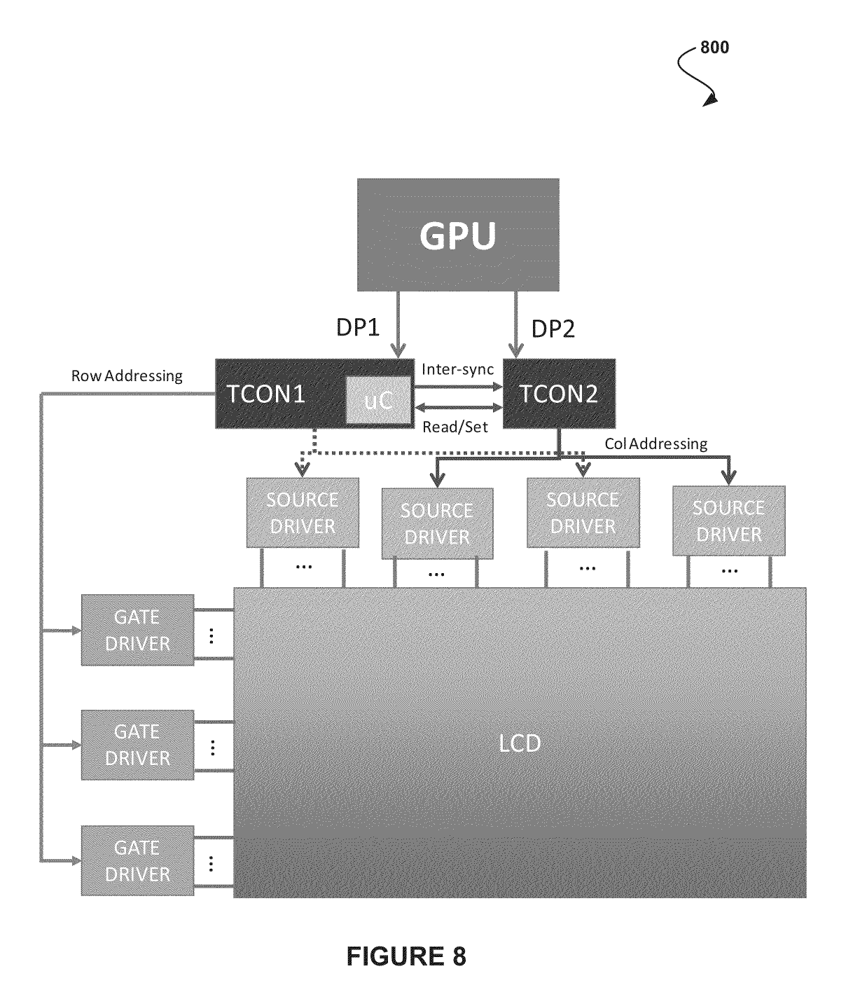

FIG. 8 illustrates a system 800 with a single GPU, timing controllers having bi-directional communication therebetween, and multiple display interfaces for distributed processing of overlapping portions of pixels, in accordance with another embodiment. As an option, the system 800 may be implemented in the context of the functionality of environment of FIGS. 1-3. Of course, however, the system 800 may be implemented in any desired environment. It should also be noted that the aforementioned definitions may apply during the present description.

The system 800 of FIG. 8 operates similarly to that system 600 of FIG. 6, with the exception that bi-directional communication is established between the TCONs in the system 800 of FIG. 8. Such communication may facilitate the distributed transmission of the processed overlapping portions of an image frame across the display interfaces (shown as source drivers and gate drivers). As shown, each of the TCONs communicates with a different subset of the display interfaces, for transmitting the processed overlapping portions of the image frame to the display device in a distributed manner. In particular, each processed overlapping portion of the image frame is transmitted via a different source driver/gate driver pair such that the processed portion is written to a portion of a display screen of the display device associated with the row/column addresses of the source driver/gate driver pair.

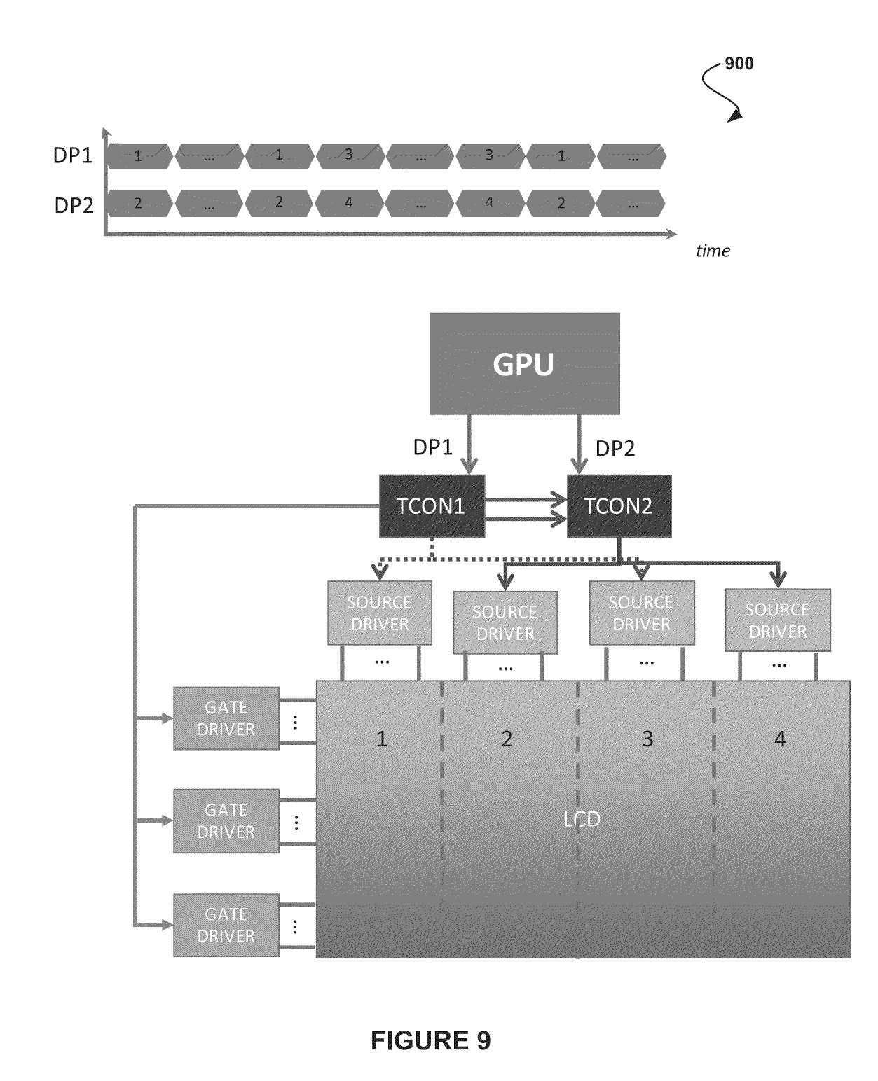

FIG. 9 illustrates a system 900 with a single GPU, timing controllers having uni-directional communication therebetween, and multiple display interfaces for distributed processing of overlapping portions of pixels, in accordance with another embodiment. As an option, the system 900 may be implemented in the context of the functionality of environment of FIGS. 1-3. Of course, however, the system 900 may be implemented in any desired environment. It should also be noted that the aforementioned definitions may apply during the present description.

The system 900 of FIG. 9 operates similarly to that system 600 of FIG. 6, with the exception that the single GPU communicates with two TCONs to drive four display devices. Unidirectional communication is established between the TCONs to facilitate the distributed transmission of overlapping portions of an image frame processed by the GPU. As shown, the first TCON receives from the GPU two processed overlapping portions of the image frame that are to be displayed by display device #1 and #3, respectively, whereas the second TCON receives from the GPU two processed overlapping portions of the image frame that are to he displayed by display device #2 and #4, respectively. The unidirectional communication between the TCONs enables the distributed transmission of the processed overlapping portions of the image frame, such that each processed is transmitted to a different source driver/gate driver pair controlling a particular portion of one of the display devices.

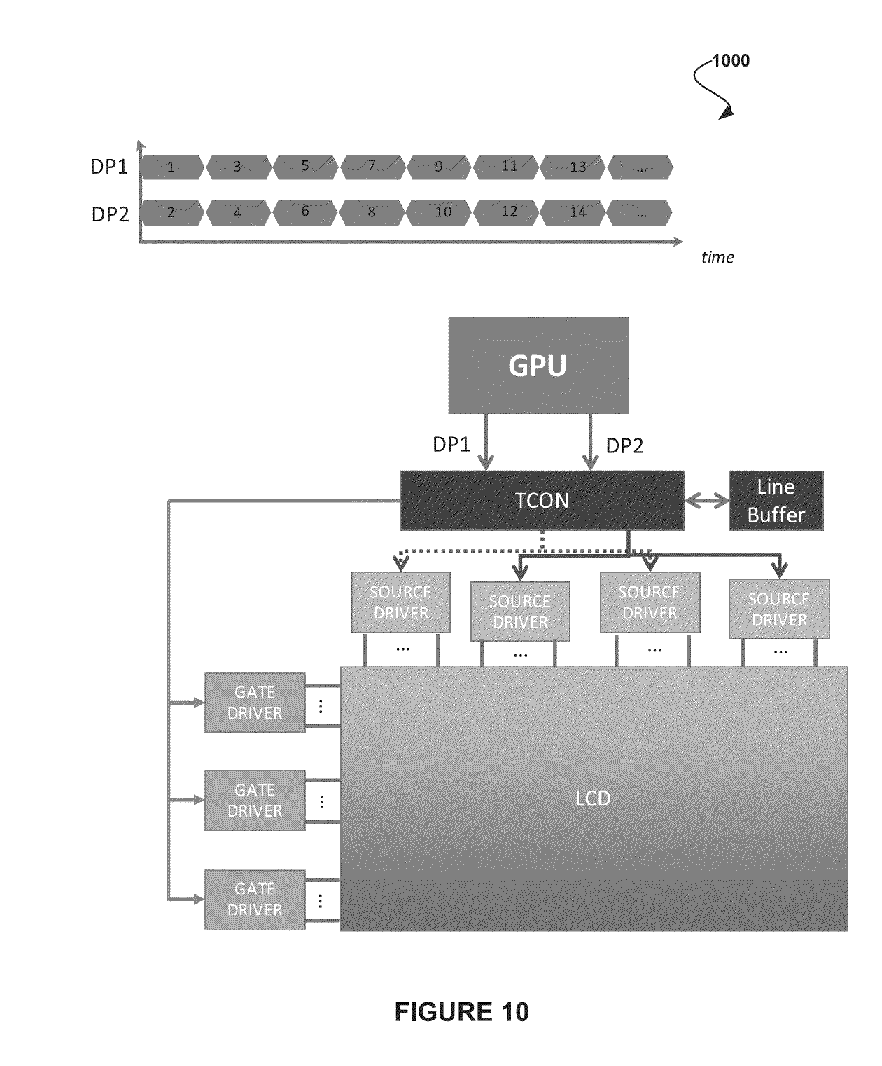

FIG. 10 illustrates a system 1000 a system with a single GPU, a single timing controller in communication with a line buffer, and multiple display interfaces for distributed processing of overlapping portions of pixels, in accordance with another embodiment. As an option, the system 1000 may be implemented in the context of the functionality of environment of FIGS. 1-3. Of course, however, the system 1000 may be implemented in any desired environment. It should also be noted that the aforementioned definitions may apply during the present description.

As shown, a single CPU is in communication with a single TCON to provide distributed processing and further transmission of overlapping portions of an image frame to a display device. The CPU alternately communicate processed overlapping portions of an image frame with the TCON via the two communication busses (D1 and D2). Additionally, the ICON uses a line buffer to store the processed overlapping portions of an image frame received from the CPU prior to transmitting such portions to the display in a distributed manner via various the display interfaces (i.e. source driver/gate driver pairs).

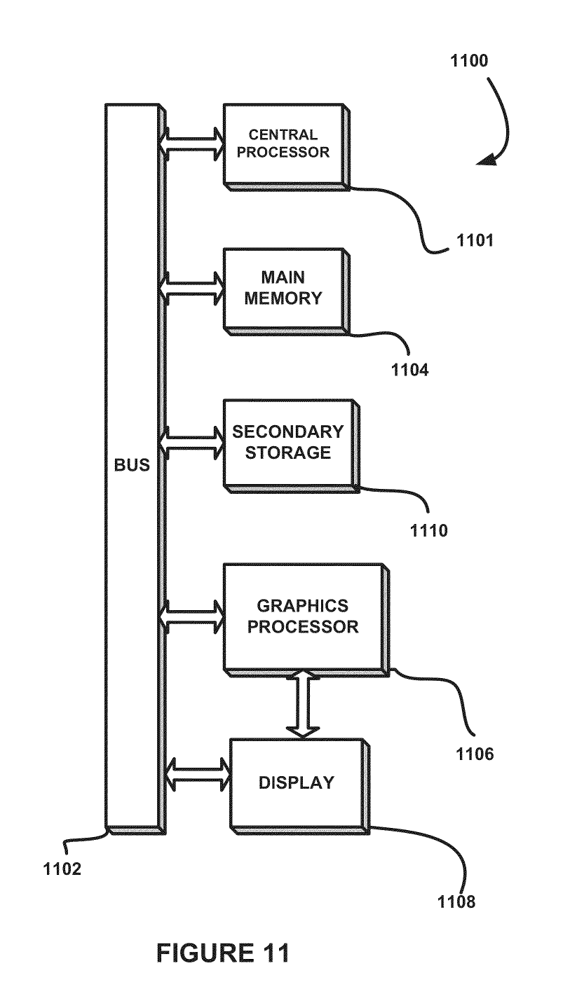

FIG. 11 illustrates an exemplary system 1100 in which the various architecture and/or functionality of the various previous embodiments may be implemented. As shown, a system 1100 is provided including at least one host processor 1101 which is connected to a communication bus 1102. The system 1100 also includes a main memory 1104. Control logic (software) and data are stored in the main memory 1104 which may take the form of random access memory (RAM).

The system 1100 also includes a graphics processor 1106 and a display 1108, i.e. a computer monitor. In one embodiment, the graphics processor 1106 may include a plurality of shader modules, a rasterization module, etc. Each of the foregoing modules may even be situated on a single semiconductor platform to form a graphics processing unit (CPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 1100 may also include a secondary storage 1110. The secondary storage 1110 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 1104 and/or the secondary storage 1110. Such computer programs, when executed, enable the system 1100 to perform various functions. Memory 1104, storage 1110 and/or any other storage are possible examples of computer-readable media.

In one embodiment, the architecture and/or functionality of the various previous figures may be implemented in the context of the host processor 1101, graphics processor 1106, an integrated circuit (not shown) that is capable of at least a portion of the capabilities of both the host processor 1101 and the graphics processor 1106, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 1100 may take the form of a desktop computer, lap-top computer, and/or any other type of logic. Still yet, the system 1100 may take the form of various other devices in including, but not limited to a personal digital assistant (PDA) device, a mobile phone device, a television, etc.

Further, while not shown, the system 1100 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying a plurality of pixels to be processed utilizing a plurality of display processing modules, and/or a plurality of display interfaces;
apportioning the pixels into a plurality of overlapping portions of the pixels in accordance with a number of the processing modules and a number of the display interfaces;
distributing processing of the overlapping portions of the pixels across the processing modules; and
distributing transmission of the overlapping portions of the pixels across the display interfaces.

2. The method of claim 1, wherein the pixels from the portions are capable of being combined to form a single contiguous image frame.

3. The method of claim 1, wherein the pixels are identified in response to being received from an application.

4. The method of claim 1, wherein the pixels are apportioned into at least the same number of overlapping portions as the number of the processing modules and/or display interfaces.

5. The method of claim 1, wherein each of the overlapping portions has pixels overlapping with at least one other of the overlapping portions.

6. The method of claim 1, wherein the pixels are apportioned into adjacent blocks of pixels such that each of the overlapping portions is one of the adjacent blocks of pixels.

7. The method of claim 6, wherein for each of the overlapping portions, the overlapping portion has pixels overlapping with the other ones of the overlapping portions to which the overlapping portion is adjacent.

8. The method of claim 1, wherein scaling the image in each of the overlapping portions to form a single contiguous whole image frame is accomplished by reusing pixels of neighboring overlapping portions in a scaling filter.

9. The method of claim 1, wherein an extent to which the portions overlap is computed based on a size of a final image, a number and arrangement of the portions, and a degree of image filtering required from each portion.

10. The method of claim 1, wherein a determined amount of overlap of the overlapping portions may be pre-fixed or dynamically programmed into a display device controller.

11. The method of claim 9, wherein the extent to which the portions overlap is predefined to be a sub-block of pixels.

12. The method of claim 1, wherein distributing processing of the overlapping portions across the processing modules includes sending to each of the processing modules a different one of the overlapping portions.

13. The method of claim 1, wherein the processing includes scaling.

14. The method of claim 1, wherein the processing includes dithering.

15. The method of claim 1, wherein the processing modules are components of a single graphic processor.

16. The method of claim 1, wherein the processing modules are components of a plurality of graphic processors.

17. The method of claim 1, wherein the processing of each of the overlapping portions uses at least a first portion of pixels included therein that overlap with at least one other of the overlapping portions to process at least a second portion of pixels included therein that do not overlap with at least one other of the overlapping portions.

18. The method of claim 1, wherein overlapping pixels included in the output resulting from the processing are discarded by a display controller.

19. The method of claim 18, wherein the overlapping pixels are discarded prior to being displayed on a screen of a display device.

20. The method of claim 19, wherein the overlapping pixels are discarded by a display controller and remaining ones of the pixels in the output are displayed by the display device.

21. A computer program product embodied on a non-transitory computer readable medium, comprising:
computer code for identifying a plurality of pixels to be processed utilizing a plurality of display processing modules, and/or a plurality of display interfaces;
computer code for apportioning the pixels into a plurality of overlapping portions of the pixels in accordance with a number of the processing modules and a number of the display interfaces;
computer code for distributing processing of the overlapping portions of the pixels across the processing modules; and
computer code for distributing transmission of the overlapping; portions of the pixels across the display interfaces.

22. An apparatus, comprising:
a processor for:
identifying a plurality of pixels to be processed utilizing a plurality of display processing modules, and/or a plurality of display interfaces;
apportioning the pixels into a plurality of overlapping portions of the pixels in accordance with a number of the processing modules and a number of the display interfaces;
distributing processing of the overlapping portions of the pixels across the processing modules; and
distributing transmission of the overlapping portions of the pixels across the display interfaces.

23. The apparatus of claim 22, wherein the processor remains in communication with memory and a display via a bus.
